(19) United States
(12) Patent Application Publication
(10) Pub. No.: US 2005/0152227 A1
(43) Pub. Date: Jul. 14, 2005

(54) Bracelet fastening device for watches and jewelry

(75) Inventor: Andre Saunier, Courgenay (CH)

Correspondence Address: PEARNE & GORDON LLP, 1801 EAST 9TH STREET, SUITE 1200, CLEVELAND, OH, 44114-3108, US

(73) Assignee: Hart Case Corp., Purchase, NY (US)

(21) Appl. No.: 11/032,927

(22) Filed: Jan. 11, 2005

(30) Foreign Application Priority Data
Jan. 13, 2004 (CH) CH00043/04

(51) Int. Cl. G04B 37/00

(52) U.S. Cl. 368/282

(57) ABSTRACT

Bracelet fastening device for watches and jewels allowing the user to change the bracelet rapidly and without tool. The bracelet strand (14) is held by the horns (4) of the middle that are not parallel to one another and that form a narrowing so as to resist to traction. The locking of the bracelet strand (14) along the vertical axis is ensured by a tongue (6) introduced in at least one recess (17) of the bracelet strand. The tongue is placed in this position following an action on a sliding part of the watch or jewel.

### REFERENCE DATA

This application claims priority from Swiss patent application CH00043/04 filed on Jan. 13, 2004, the contents of which are hereby incorporated by reference.

### FIELD OF THE INVENTION

The present invention concerns a bracelet fastening or attaching device or connecting element for watches and jewels.

### DESCRIPTION OF RELATED DATA

An important element of a watch's exterior is the bracelet allowing it to be fastened to the wrist.

The evolution of customs and fashions has created new needs, notably as regards the changing of the bracelet to adapt it to circumstances, clothing or current fashion.

Quality watches often use conventional bracelet fastening means, i.e. horns or protuberances with a place for the bracelet's extremity. This bracelet can be of leather, metal or any other existing material suited for this use. In order to ensure that the bracelet is reliably fastened on the watch, it is necessary to make them firmly united along three axes, defined in space as described here after (FIG. 1): the longitudinal axis 1, represented by the watch's 6 o'clock-12 o'clock line, the transverse axis 2, parallel to the 3 o'clock-9 o'clock line, and the vertical axis 3, perpendicular to the other two axes.

On most bracelet fastening systems, a cylindrical lug is used, of which at least one of the two pivots is mobile. This lug is firmly united with the bracelet's strand through a traversing opening made through the latter. The pivots are lodged in opposite borings provided to this effect in the horns or protuberances of the watch. In this manner, the bracelet is firmly united with the watch, through the lug, on the longitudinal axis and on the vertical axis. The locking on the transverse axis is ensured in both directions by the two horns or protuberances of the watch since the distance in-between these two horns is practically equal to the width of the bracelet's strand. Ordinarily, the inner sides of the horns, in which borings are made to receive the lug's pivots, are parallel to one another, and generally parallel to the longitudinal axis 1 of the watch.

Changing the bracelet can thus be effected neither instantly nor easily by the watch's wearer. The latter must thus request the assistance of the vendor who uses suitable tools.

The present invention aims to furnish a bracelet fastening device answering the new needs, as described here above, namely to allow the user to change the bracelet easily, without tools and reliably.

Many patents are known that have in common proposals for resolving the same problem: how to change a watch bracelet oneself rapidly and without tool, yet ensuring the reliability of the clasp.

Patent EP0461069 proposes a rotating bezel provided with two protuberances which, in normal position, overlap over two other complementary protuberances that are part of the watch's middle and containing each a lodging for receiving the two strands of the bracelet provided with their respective lug. The inconvenience of this system is that it limits the possibilities of creating new shapes for the watch cases or for the jewel, because it compulsorily comprises a rotating bezel provided with protuberances.

Patent CH216721 uses the same principle of a rotating bezel overlapping over, and locking, the bracelet's fastening area. It allows supple bracelets, e.g. of leather, to be fastened by means of a rigid fastening element that comes to rest in the lodging, united with the middle, and covered by the protuberance of the rotating bezel when it is locked. This solution has the same inconvenience as the preceding one.

Patent FR709518 is a proposal similar to the preceding one, with an embodiment that is a formed case, i.e. not circular. The inconvenience of this invention, dating back to 1931, is that it no longer corresponds to the technical criteria of watches as they are designed nowadays.

### BRIEF SUMMARY OF THE INVENTION

The aim of the invention is achieved when the inner sides of the horns or protruding elements of the watch are at least partly not parallel. In a preferred embodiment, they present, as seen from above, an opening made in the watch, for example in the shape of a dovetail, as shown in the embodiment illustrated in FIG. 1. This opening can in fact appear in different shapes, as long as they display a narrowing at the extremity of the horns or of the protuberances.

This opening, made in the watch, can traverse the width of the middle through and through. It can also be made only to a certain depth, either from above or from below the middle.

Since the bracelet's strand has a shape similar to that of the aforementioned opening, it becomes united with the watch, along the longitudinal axis through the opening's dovetailing, and along the transverse axis through the two horns or protuberances of the middle.

As the bracelet's strand does not comprise lugs, its locking on the vertical axis is ensured by a tongue, visible in FIG. 1, that is displaced, in a preferred embodiment, by actuating a sliding element of the watch.

Since it is usual for the bracelet's strand containing the clasp to be fastened at 12 o'clock, the horns are, in a variant embodiment of the invention, slightly different for each strand in order to ensure their correct positioning. Similarly, the shapes of the various elements of the fastening device will preferably not allow the strands to be mounted upside-down, i.e. with the inner side of the bracelet mounted outwards.

Thanks to this new design, the bracelet is firmly united with the watch on its three axes. The fastening is thus ensured and reliable.

### BRIEF DESCRIPTION OF THE DRAWINGS

The embodiments of the invention, chosen as non-limiting examples, are now described with the aid of the following drawings in which:

FIG. 1 shows a watch case without the bracelet, according to the invention, seen from above.

FIG. 2 shows an identical watch case, profiled at three o'clock.

FIG. 3 shows an identical watch case, profiled at six o'clock.

FIG. 4 shows an identical watch case, seen from below.

FIG. 5 shows a cross section along the six o'clock-12 o'clock line of the same watch case.

FIG. 6 shows a cross section along the three o'clock-nine o'clock line of the preceding ensemble.

FIG. 7 shows another cross section along the six o'clock-twelve o'clock line of the preceding ensemble with fastening tongue and bracelet strands.

FIG. 8 shows a view from below of the preceding ensemble with the fastening tongue in open position.

FIG. 9 shows a cross section along the three o'clock-nine o'clock line of the preceding ensemble.

FIG. 10 shows a bracelet strand corresponding to the preceding ensemble.

### DETAILED DESCRIPTION OF THE INVENTION

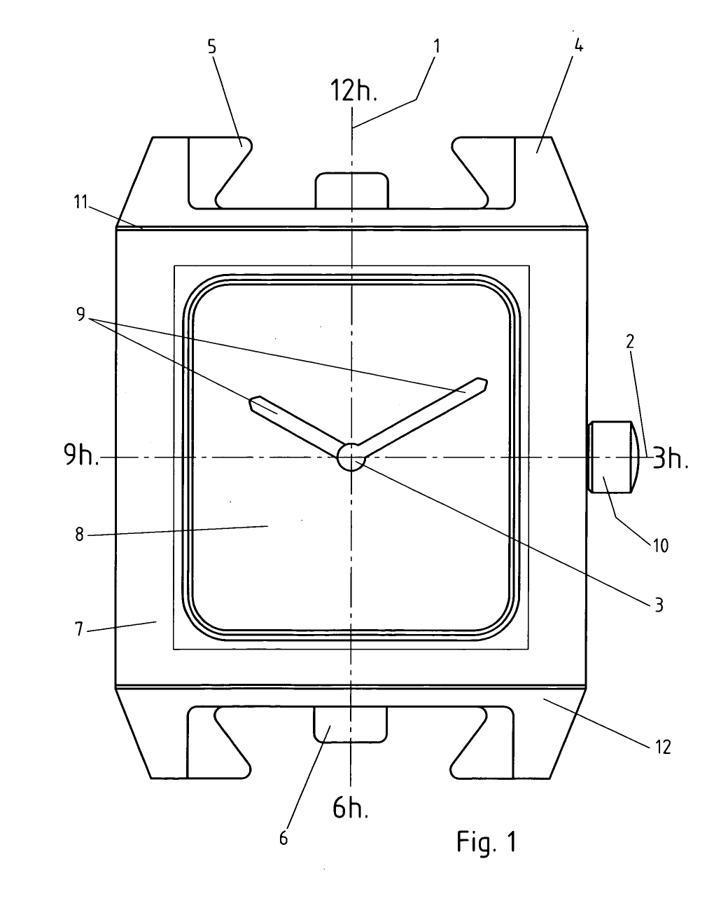

FIG. 1 represents a watch case according to a preferred embodiment of the invention, seen from above. The watch case comprises a middle 12 and a container 7. The middle 12 comprises two pairs of horns 4 for receiving each a strand of a bracelet (not represented in FIG. 1). The pairs of horns 4 are preferably situated at six o'clock and at twelve o'clock such that the bracelet is attached parallel to the longitudinal axis 1. Other positions are however possible, thus resulting in different alignments of the bracelet relative to the watch case. In the embodiment of FIG. 1, a part of the inner sides of the horns 4 is parallel to the axis 1, whilst the other part 5 has a dovetail shape. This implies that the extremities of the bracelet's two strands that will lodge in-between the horns 4 will have the counter-shape of this space, in particular as regards part 5.

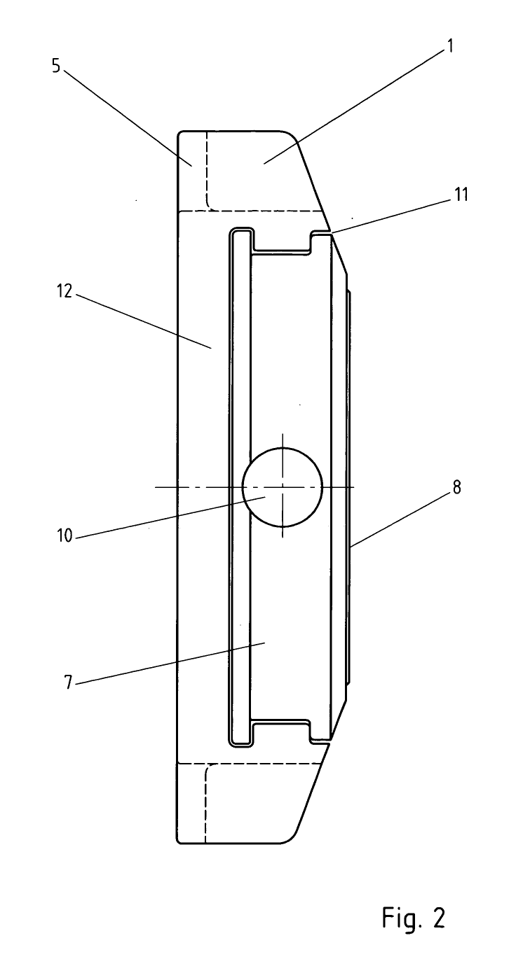

Between each pair of horns 4 is a tongue 6. Each tongue 6 is a protuberance united with a sliding part of the watch, for example to a part called container 7 which comprises the usual elements of a time-keeper. On FIG. 1, the glass 8, hands 9 and crown 10 are visible. In reference 11, the double line symbolizes the sliding zone between the middle 12 comprising the horns 4, and the container 7. This movement between these two parts of the watch allows the tongues 6 to be displaced relative to the middle 12 along the transverse axis 2, which ensures, as explained later, that the bracelet's strands will be locked along the vertical axis 3. FIG. 2 is a profile at three o'clock of the watch case of FIG. 1. This view clearly shows the container 7 and the middle 12, separated by the sliding zone 11. It also shows the dovetail part 5 of the horn 4, located on its lower part.

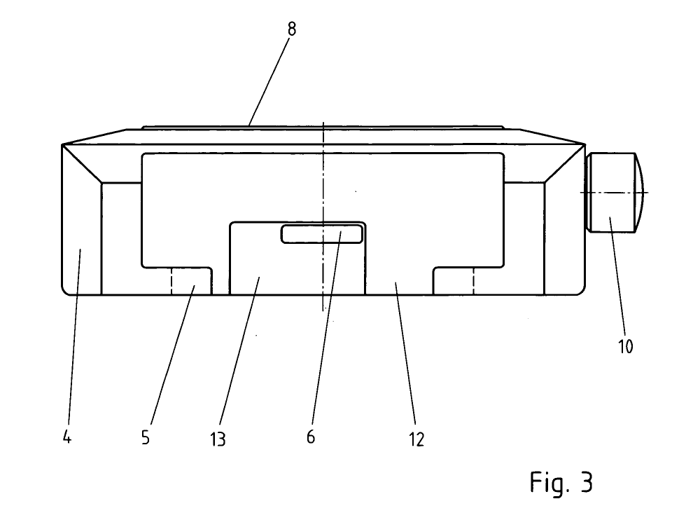

FIG. 3 is a profile at six o'clock of the watch case of FIG. 1. It shows in particular one of the tongues 6 and a hollow 13 in the middle 12 that allows the tongue 6 to be displaced along the transverse axis when the container is slid relative to the middle 12.

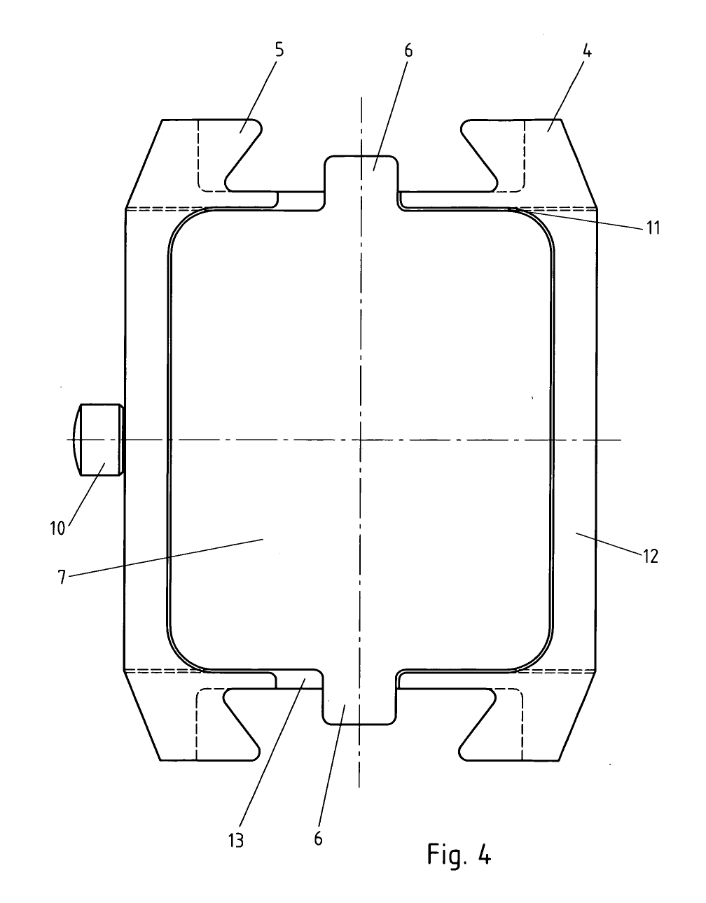

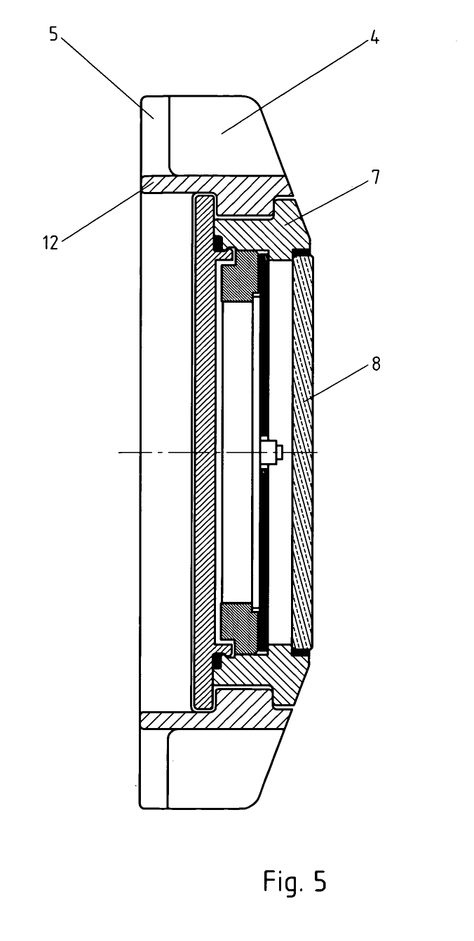

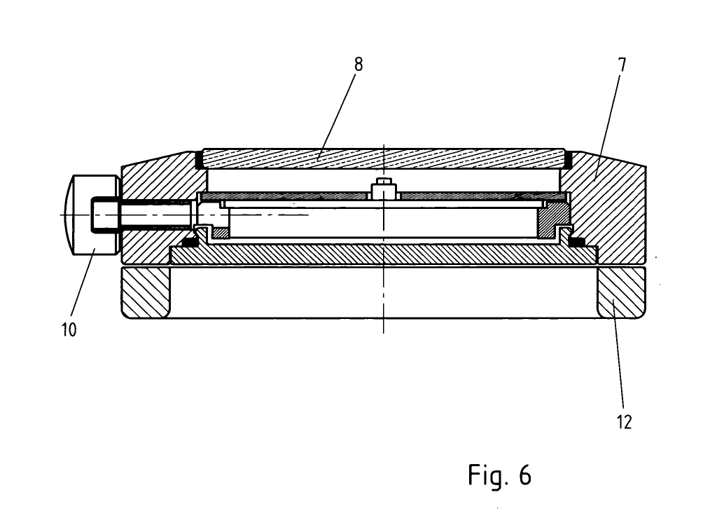

FIGS. 4, 5 and 6 show one view and two cross sections of the different elements already described here above.

FIG. 4 illustrates the watch case of FIG. 1 seen from below in locked position. In this position, the container 7 is preferably centered relative to the middle 12. In locked position, the tongues 6 are preferably at an equal distance of each horn 4 of the corresponding pair. In the illustrated example, the middle 12 is opened in its center and the container 7 is visible from the lower side of the watch case. In a variant-embodiment, the lower side of the container 7 is at least partly transparent, thus allowing the watch movement to be visible from below the watch. In another embodiment, the middle 12 is closed in its lower part and the container 7 is only accessible from the upper side and two lateral sides of the watch case.

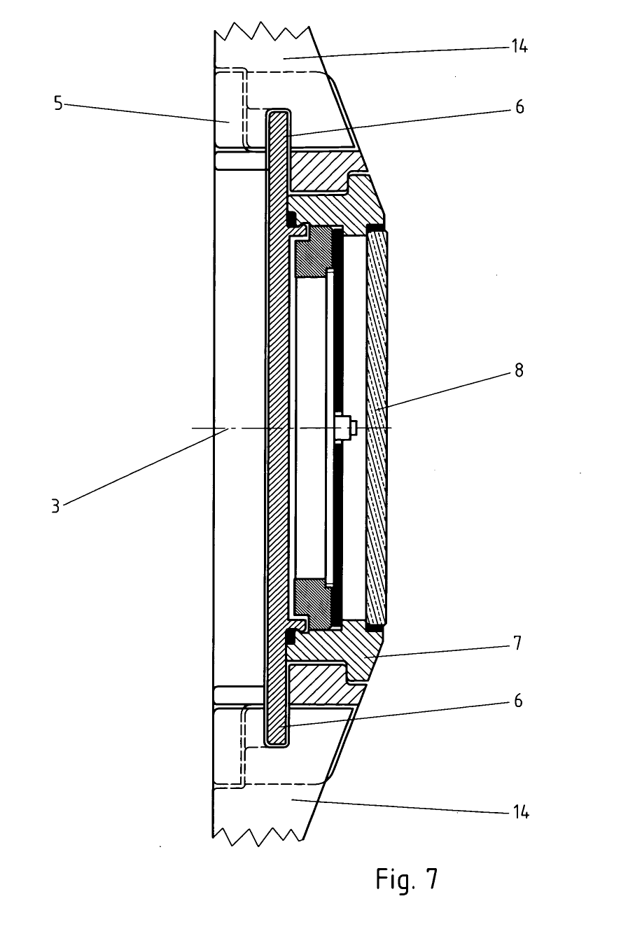

FIG. 7 is a cross section along the six o'clock-twelve o'clock line integrating the two strands of the bracelet 14. It shows the two tongues 6 locking the strands of the bracelet 14 along the vertical axis 3.

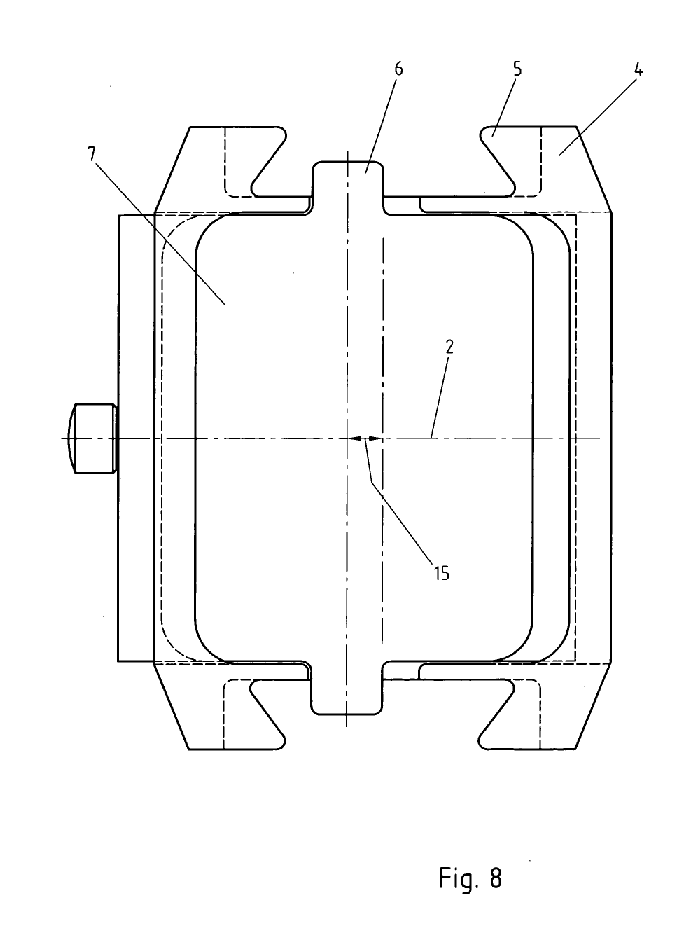

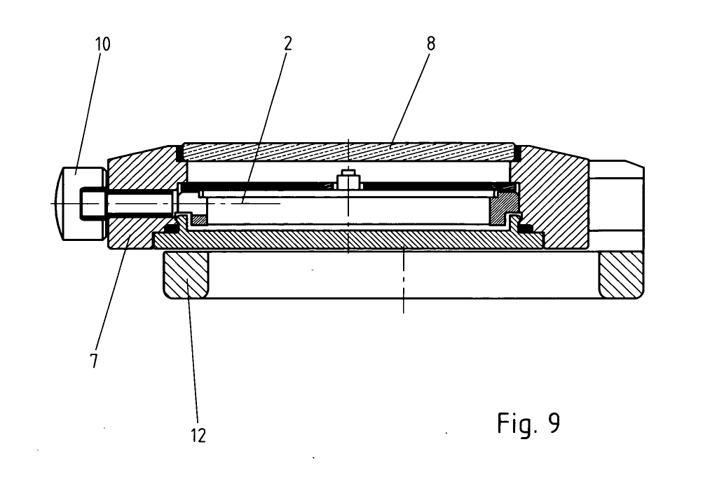

FIG. 8 illustrates the displacement of the container 7 and of the tongues 6 in opened position. As indicated in FIG. 9, this open position is characterized by the fact that the container 7 has been displaced transversally along the transverse axis 2. In this position, the bracelet's strands can be removed and replaced by others.

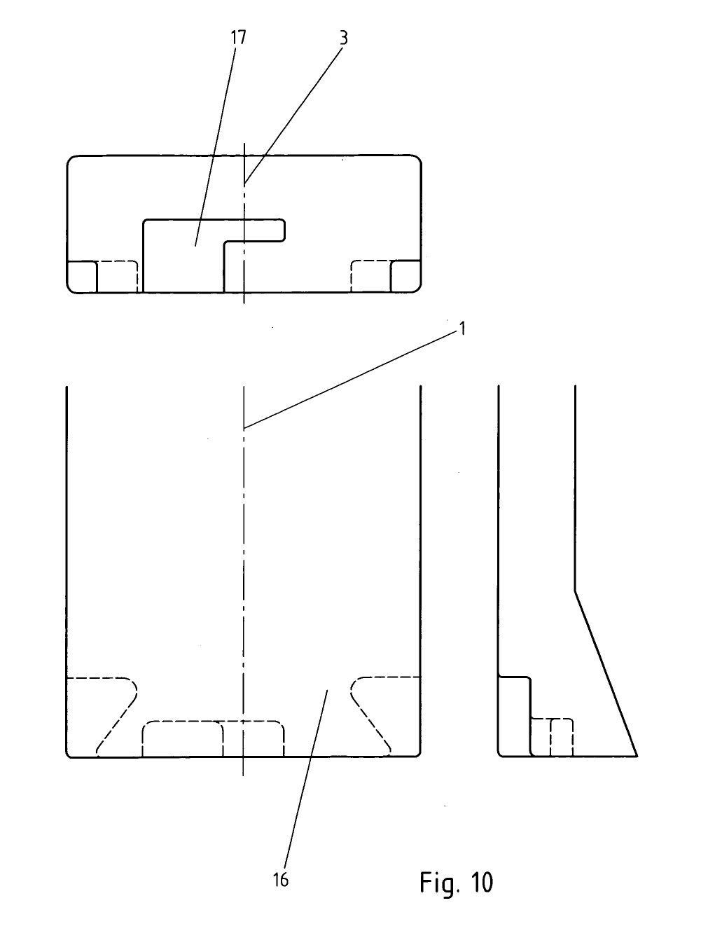

FIG. 10 is three views from different angles of a bracelet strand's extremity according to a preferred embodiment of the invention. It shows that the strand's extremity is for example reinforced by an insert 16, rigid, that moulds itself to fit the shape of the space in-between a pair of horns of the middle. In the side of the insert 16, parallel to the axis 3, is a recess 17 in which the tongue is set when the strand is put in place and locked. The transversal displacement of the container 7 when it is juxtaposed over the middle 12, ensures the locking of the bracelet's two strands along the vertical axis. The container 7 is preferably held in this locked position by a holding device, not represented on the figures. The holding device includes for example a ball bearing mounted on springs or a ratchet, or any other mechanism in order to maintain the position of the container 7 relative to the middle 12.

In the embodiment illustrated in the FIGS. 1 to 10, the upper parts of the horns 4 have parallel inner sides and participate to the aesthetic aspect of the watch when a bracelet is fastened to the case, whilst the lower parts of their inner sides form a narrowing in a dovetail shape and are preferably at least partly covered by the bracelet when the latter is fastened to the watch case.

Other shapes are possible for the horns 4 within the framework of the invention. According to a variant embodiment, the upper parts of the horns form a narrowing close to the end of the horns whilst the inner sides of their lower part are parallel to the longitudinal axis. The narrowing is then for example visible from the upper side of the watch when the bracelet is fastened to the case and thus possibly contributes to the aesthetic aspect of the watch. In another embodiment, the narrowing is formed over the entire height of the horns. It is then for example visible from the upper side and from the lower side of the watch when the bracelet is fastened to the case.

In the illustrated embodiment of the invention, both pairs of horns 4 and both tongues 6 are identical to each other. It is however possible, within the framework of the invention, to conceive a watch case or a jewel having two pairs of horns of different shapes. This further brings the advantage that both bracelet strands have differently shaped extremities, thus preventing them from being fastened to the wrong place. It is also possible to imagine a watch case or a jewel having only one pair of horns according to the invention and possibly one other pair of horns of a conventional type, such that for example only one strand of the bracelet can be changed by the user himself.

The spacing delimited by two horns 4 of a same pair defines a lodging for the extremity of a bracelet strand 14. Preferably, the width of the strand's extremity is approximately equal to the distance between the inner sides of the horns 4, such that, when placed in its lodging, the strand 14 is held in both directions along a first axis, for example along the transverse axis 2. According to the invention, the horns 4 of a same pair further form a narrowing on at least part of the horns' height, preferably close to the extremity of the horns 4. The strand's extremity is preferably rigid and formed to comply with this narrowing, such that the strand is held along a second axis, for example along the longitudinal axis 2, when it is correctly placed in the lodging. In the illustrated example, the narrowing is in the shape of a dovetail. Other forms are however possible within the framework of the invention. The parts of the horns protruding within the lodging for holding the bracelet's strand in one or preferably both directions along the second axis can for example have circular, rectangular, triangular or any other shapes.

When the bracelet fastening device of the invention is in locked position and a strand 14 is correctly placed in its lodging, the corresponding tongue 6 holds the strand in both directions along a third axis, for example along the vertical axis 3, through insertion in a corresponding recess 17 in the preferably rigid strand's extremity (FIG. 7).

In the illustrated example, the tongues 6 are united with the container 7 containing the elements of the time-keeper such as for example the watch movement, the hands, etc. According to a variant embodiment, the tongues 6 are not united with a container 7, but with another mobile element located for example under and/or inside the middle 12. The mobile element can then be accessed and actuated for example from the lower side and/or from a lateral side of the watch case. Preferably, both tongues are united with the same mobile element. It is however possible, within the framework of the invention, to unite each tongue 6 with a different mobile element, such that each strand can for example be locked or unlocked independently. The elements of the time-keeper such as the watch movement, the hands, etc., can then be integrated directly within the middle 12 and do not need to be placed in a mobile container such as the illustrated container 7.

If a metallic bracelet is used, the first link has the shape and the elements allowing it to be set in the space or lodging in-between the horns of the watch case and to be fastened there according to the same principles of those described here above.

The invention is not limited to use of bracelet strands with rigid inserts or of metallic bracelets. It is enough for the part of the strands placed in the space in-between the horns of the middle 12 to be sufficiently rigid to be held by the horns' or protuberances' narrowing at their extremities, despite a considerable traction being exerted on the strands.

The invention is described above in its application to a watch, in particular to a wrist watch. The bracelet fastening device of the invention can however also be applied to a jewel, whereas the horns are united with a base element of a part of the jewel whilst the tongue or tongues are united with a mobile element which is attached to the base element and can slide relative to it.

1. A bracelet fastening device for watches and jewels allowing the user to change the bracelet himself, without tool and fully reliably, wherein the watch or jewel has at least two horns or protuberances that are not parallel since they are constituted by an opening in the watch or jewel that can be in different shapes, for example in dovetail shape, as long as said opening displays a narrowing at the extremity of the horns or protuberances and is placed on at least one part of the thickness of the watch or jewel, and wherein the extremity of a bracelet strand or metallic bracelet corresponding to said opening has a similar shape, so as to be positioned in this opening and becoming firmly united with the watch or jewel along a longitudinal axis and a transverse axis, whilst the locking of the bracelet strand along the vertical axis is ensured by at least one tongue introduced in at least one recess of the bracelet strand, said tongue being placed in this position following an action on a sliding part of the watch or jewel.

2. The bracelet fastening device for watches and jewels of claim 1, the watch or jewel being constituted of a middle comprising horns and a container including the usual elements of a time-keeper, and the opening designed to receive the extremity of the bracelet strand being made in the middle of the watch or jewel, said middle further having at least one hollow for allowing the tongue to pass and the container constituting the sliding part of the watch or jewel, which is united with the tongue.

3. The bracelet fastening device for watches and jewels of claim 1, the opening being made through the entire thickness of the watch or middle.

4. The bracelet fastening device for watches and jewels of claim 1, the opening being made from above or below the watch or the middle and on one part only.

5. The bracelet fastening device for watches and jewels of claim 1, the opening being made from below the watch or middle and on one part only, whilst the rest of the width is open so that the space in-between the horns, visible from above, is parallel.

6. The bracelet fastening device for watches and jewels of claim 2, wherein the bracelet strand can be put in place when the container has been displaced transversally relative to the middle, said bracelet strand being locked when the container is replaced in its initial position, namely juxtaposed over the middle, further wherein the container is held in this position by a holding element, for example a ball bearing mounted on a spring or a ratchet.

7. The bracelet fastening device for watches and jewels of claim 1, the extremity of the bracelet strand being reinforced by an insert, rigid-, on the side of which is located the recess where the tongue is placed when the bracelet strand is put in place.

8. The bracelet fastening device for watches and jewels of claim 1, wherein the bracelet strand containing the clasp, due to the shape of its extremity, can be fastened only at the twelve o'clock position of the watch or jewel.

9. The bracelet fastening device for watches and jewels of claim 1, wherein the bracelet strand, due to the shape of its extremity, cannot be mounted incorrectly.

10. A watch case or part of jewel comprising:
at least two cooperating protruding portions for limiting the displacement of a bracelet strand along a longitudinal axis of said bracelet strand and a transverse axis of said bracelet strand,
a mobile element which can be slid along an axis relative to said at least two cooperating protruding portions between a locked position and an unlocked position so as to limit the displacement of said bracelet strand along a vertical axis of said bracelet strand in said locked position, and to allow the changing of said bracelet strand in said unlocked position.

11. The watch case or part of jewel of claim 10, said at least two cooperating protruding portions comprising at least two horns united with a base element, said at least two horns having a narrowing at their end on at least a part of their thickness,
said mobile element being attached to said base element such that it can be slid along an axis relative to said base element between said locked position and said unlocked position.

12. The watch case or part of jewel of claim 11, said narrowing having a dovetail shape.

13. The watch case or part of jewel of claim 10, said mobile element comprising a tongue introduced in a recess in said bracelet strand when in said locked position.

14. The watch case or part of jewel of claim 13, said tongue being placed between said at least two cooperating protruding portions in said locked position.

15. A bracelet strand comprising an extremity with a recess, said recess being at least partly closed on two opposite sides such that a tongue which would be introduced in said recess would be held in both directions along an axis perpendicular to said opposite sides.

16. The bracelet strand of claim 15, said extremity being rigid.

17. The bracelet's strand of claim 16, said extremity being a rigid insert within said strand.

18. A watch or jewel, comprising:
a watch case or part of jewel,
a bracelet strand attached to said watch case or part of jewel,
said watch case or part of jewel comprising at least two cooperating protruding portions for limiting displacement of said bracelet strand along a longitudinal axis of said bracelet strand and a transverse axis of said bracelet strand, and a mobile element which can be slid along an axis relative to said at least two cooperating protruding portions between a locked position and an unlocked position so as to limit the displacement of said bracelet strand along a vertical axis of said bracelet strand in said locked position, and to allow the changing of said bracelet strand in said unlocked position.

19. The watch or jewel of claim 18, said mobile element comprising a tongue, an extremity of said bracelet strand comprising a recess at least partly closed on two opposite sides, said tongue being inserted in said recess in said locked position, such that said tongue is held in both directions along an axis perpendicular to said opposite sides.

20. The watch or jewel of claim 19, said axis perpendicular to said opposite sides being parallel to said vertical axis.
